(19) United States
(12) Patent Application Publication
(10) Pub. No.: US 2007/0137010 A1
(43) Pub. Date: Jun. 21, 2007

(54) Jewelry post connector system with required complimentary separate actuator for removal

(76) Inventors: Rachel Marie Ivey, Chandler, AZ (US); Jonathan Loyd Lee Ivey, Chandler, AZ (US)

Correspondence Address: KEITH L. JENKINS, 2222 NORTH MCQUEEN ROAD #2069, CHANDLER, AZ, 85225, US

(21) Appl. No.: 11/534,652

(22) Filed: Sep. 23, 2006

Related U.S. Application Data
(60) Provisional application No. 60/720,019, filed on Sep. 24, 2005.

(51) Int. Cl. F16B 21/00

(52) U.S. Cl. 24/704.2

(57) ABSTRACT

A system is provided for removably securing a jewelry post of an article of jewelry. The system includes a jewelry post connector having an engaging member operable in a first position to limit motion of the jewelry post of the article of jewelry and operable in a second position to release the jewelry post of the article of jewelry. The system also includes a web coupled to the engaging member and configured to prevent direct manipulation of the engaging member by human fingers and to further to prevent direct manipulation of the engaging member by any means integral to the jewelry post connector. The system further includes a complimentary separate actuator for removing the jewelry post connector from the jewelry post by moving the engaging member from the first position to the second position. An exemplary apparatus, using magnets, is disclosed.

### PRIOR APPLICATIONS

This application claims the benefit of U.S. Provisional Patent Application No. 60/720,019 filed Sep. 24, 2005.

### FIELD OF THE INVENTION

The present invention generally relates to jewelry connectors, and more particularly relates to a jewelry post connector that cannot be directly disconnected by hand but which requires a separate actuator for removal.

### BACKGROUND OF THE INVENTION

Some connectors for securing jewelry posts, such as the posts of earrings for pierced ears, are known in the art. Many jewelry-post connectors (also called clutches, clasps, retaining devices, etc.) rely on resilient members biased against the post, perhaps in grooves in the post adapted to that purpose, in order to secure the connector onto the post. The known connectors are attached and detached by hand, limiting the strength of the resilient members to that strength that can be easily compressed with the fingers. As a result, and as recognized by the present inventors, earrings are sometimes lost because the connector's weak connection to the post fails. Another disadvantage of the existing connectors is that a clever thief may deftly remove the finger-operated connector.

Accordingly, it is desirable to provide a jewelry-post connector that cannot be removed by hand. In addition, it is desirable to provide a customized actuator for removing such connectors. Further, it is desirable to provide various approaches to actuating removal of such connectors. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A system is provided for removably securing jewelry to a portion of the human body or to clothing by means of a jewelry post connector with a required complimentary separate actuator for removal of the connector. The system comprises a connector having an engaging member operable in a first position to limit the motion of a jewelry post and operable in a second position to release a jewelry post, a web configured to prevent manual access to the engaging member, and an actuator operable to move the engaging members from their first position to their second position.

### BRIEF DESCRIPTION OF THE DRAWINGS

The present invention will hereinafter be described in conjunction with the following drawing figures, wherein like numerals denote like elements, and

FIG. 1A is a sectional elevation view illustrating an exemplary jewelry post connector in an intermediate position while being installed, according to an exemplary embodiment of the present invention;

FIG. 1B is a sectional elevation view illustrating an exemplary jewelry post connector in an installed position with engaging members in a first position, according to an exemplary embodiment of the present invention;

FIG. 2 is a sectional elevation view illustrating an exemplary jewelry post connector being acted upon by required complimentary separate actuator to move the engaging members to a second position, according to an exemplary embodiment of the present invention;

FIG. 3A is a sectional elevation view illustrating an exemplary jewelry post connector in an intermediate position while being installed, according to a second exemplary embodiment of the present invention;

FIG. 3B is a sectional elevation view illustrating an exemplary jewelry post connector in an installed position, according to a second exemplary embodiment of the present invention;

FIG. 4A is a plan view illustrating an exemplary complimentary separate actuator according to an exemplary embodiment of the present invention;

FIG. 4B is a block diagram showing the magnets of the actuator aligned to the magnets of the jewelry post connector in the operational position for releasing the connector;

FIG. 5 is a plan view illustrating an exemplary complimentary separate actuator according to a second exemplary embodiment of the present invention; and

FIG. 6 is a plan view illustrating an exemplary complimentary separate actuator packaged with connectors configured to be used with that actuator according to an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the drawings.

“Jewelry,” or “article of jewelry,” as used and defined herein, means any item of adornment attachable to the human body (as by piercing, for non-limiting example) or to articles of apparel, including hats and shoes, by means of a jewelry post penetrating though a new or prepared hole in the material to which the jewelry is to be attached and securable by a jewelry post connector. For example and without limitation, jewelry would include earrings, pierced-body adornments, label pins, broaches, hat decorations, military uniform insignia, badges, and campaign ribbons.

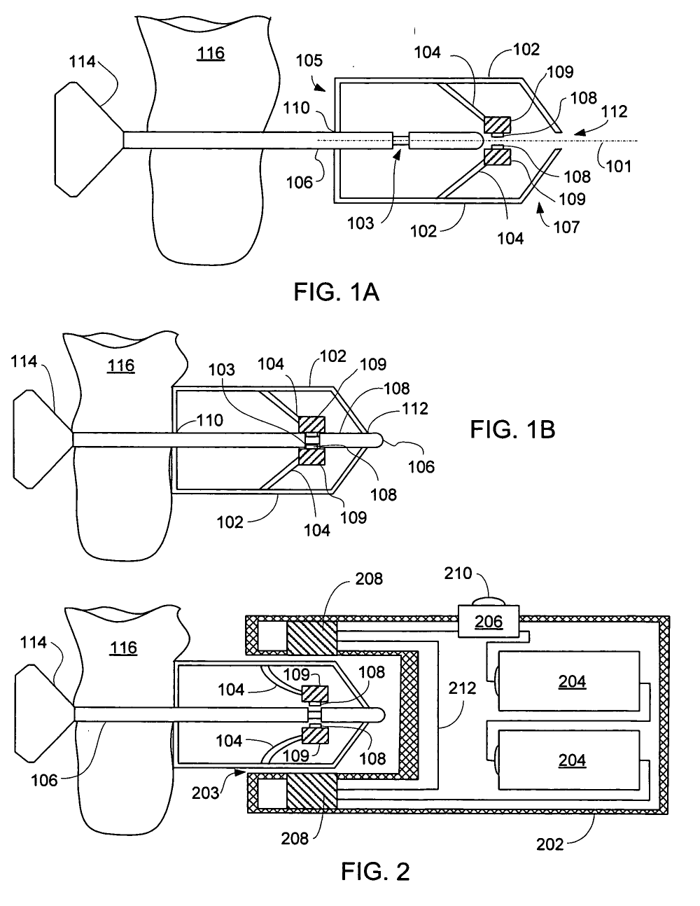

FIG. 1A is a sectional elevation view illustrating an exemplary jewelry post connector 100 (hereinafter “connector”) in an intermediate position while being installed, according to the present invention. Jewelry post 106 is shown connected to an article of jewelry 114 and is further shown pushed through a penetration in material 116, such as an earlobe, a jacket, or other jewelry-supporting material 116. The material 116 may have one or more penetrations adapted to receive one or more jewelry posts 106. A single article of jewelry 114 may have multiple jewelry posts 106 and may required multiple connectors 100 or a single connector 100 sized, shaped, and arranged to connect to multiple jewelry posts 106. Jewelry post 106 has an indentation such as a socket or circumferential groove 103 for receiving an end piece 108 of engaging member 104, as shown. Preferably, the indentation is a groove 103, as shown, obviating control of the rotational orientation of the connector 100 in relationship to the jewelry post 106. Those skilled in the art, upon reading the teachings of this specification, will appreciate that, under appropriate circumstances, considering such issues as various jewelry designs, various cross-sectional shapes of jewelry posts 106, and ergonomic factors, other configurations for connector 100, such as those adapted for particular posts or combinations of posts, adapted to posts with sockets instead of grooves 103, etc., may be used with connector 100.

Jewelry post 106 is shown inserted into the web 102 of the connector 100 through first opening 110. Web 102 is shown as a substantially closed cylinder having a first end 105 proximate the material 116, a second end 107 distal from material 116, and a circumferential portion integral to first and second ends 105 and 107. The closed cylinder formed by web 102 need not have a regular circular cylindrical cross section. For example, and without limitation, an oval or triangular cross section may be used for web 102. Preferably, the first and second ends 105 and 107 have different external shapes to simplify putting the connector 100 onto jewelry post 106 in the operational direction, as shown. The first end 105 has a first opening 110 adapted to receive jewelry post 106. In a particular embodiment, a single connector 100 may have a plurality of openings 110 in first end 105, such openings sized, shaped, and arranged to receive multiple jewelry posts 106 from a single article of jewelry 114. In another particular embodiment, a single connector 100 may have a plurality of openings 110 in first end 105, such openings sized, shaped, and arranged to receive jewelry posts 106 each from a plurality of articles of jewelry 114. The second end 107 preferably has a second opening 112 that is coaxial with first opening 110, as shown. In particular embodiments, second end 107 may have a plurality of second openings 112 aligned coaxially to first openings 110. Second opening 112 allows jewelry posts 106 of various lengths to be received by the connector 100. The center of first opening 110 and the center of second opening 112 define a longitudinal axis 101 of connector 100, as shown. The funnel shape of the interior of the second end 107 assists in aligning the jewelry post 106 with the second opening 112.

Although FIG. 1A shows that the external shape of second end 107 reflects the internal shape of second end 107, the internal funnel shape of second end 107 need not determine the exterior shape of second end 107. In a particular embodiment, for example and without limitation, second end 107 may have a funnel interior shape and a circular cylindrical exterior shape. The web 102 is configured to prevent direct manipulation (as by human fingers) of the engaging members 104 or direct manipulation (as by an object) of the engaging members 104 by any means integral to connector 100. In some embodiments, the web 102 may have additional openings in web 102 created within the constraint that the engaging members 104 may not be manipulated directly by hand. The web 102 is preferably made of any substantially rigid non-magnetic or magnetically permeable material. For safety, the web 102 is preferably not made of extremely hard metal so that the connector 100 may be cut off in an emergency. Those skilled in the art, upon reading the teachings of this specification, will appreciate that, under appropriate circumstances, considering such issues as various jewelry designs, various cross-sectional shapes of jewelry posts 106, materials compatibility, manufacturing costs, and ergonomic factors, other configurations for web 102, such as those adapted for particular posts or combinations of posts, nonmagnetic actuation, ease of use, etc., may be used with connector 100.

Engaging members 104 are preferably coupled to the interior surface of the web 102 and preferably extend to a position operable to engage a jewelry post 106. End pieces 108 are sized, shaped, and arranged to be inserted into groove 103 to limit the motion of the jewelry post 106 relative to the connector 100. In an exemplary preferred embodiment, magnets 109 are coupled to end pieces 108, preferably with their magnetic poles aligned to repel each other. The reasons for this will be discussed further in the description of FIG. 2. Magnets 109 preferably have very strong magnetic fields, more preferably are rare-earth magnets, and most preferably are magnets that comprise neodymium. The end pieces 108 are preferably shaped to fit within groove 103 in such a manner that manually removing the connector 100 from the jewelry post 106 is not possible once the connector 100 is installed.

While engaging members 104 are shown as reed springs, the invention is not so limited. Any biased extensions operable to engage a jewelry post 106 may be used for engaging members 104. For example and without limitation, engaging members 104 may each be pivotable rigid extensions biased by coil springs. Preferably, the dimensions of the connector 100 should provide a connector 100 that engages jewelry post 106 at second opening 112 before the engaging members 104 engage the groove 103 in the jewelry post 106. In a particular embodiment, jewelry post 106 may have a plurality of grooves 103 and each engaging member 104 may engage only one of the grooves 103. In another particular embodiment, grooves 103 may be partially circumferential grooves, or sockets, and each engaging member 104 may be sized, shaped, and arranged to engage only one socket, making the correct rotational orientation of the connector 100 to the jewelry post 106 essential for engagement. Those skilled in the art, upon reading the teachings of this specification, will appreciate that, under appropriate circumstances, considering such issues as various magnetic material strengths, various designs of jewelry posts 106, load requirements, and ergonomic factors, other configurations for engaging member 104, such as those adapted for particular posts or combinations of posts, those using flanges, very high frictional abutments, spring-loaded extensions, etc., may be used with connector 100.

FIG. 1B is a sectional elevation view illustrating an exemplary jewelry post connector 100 in an installed position with engaging members 104 in a first position, according to the present invention. End pieces 108 are engaged in groove 103 to prevent removal of connector 100 from the jewelry post 106 by limiting the motion of the connector 100 relative to the jewelry post 106. Material 116 has been slightly compressed by abutment of the first end 105 to the material 116. Article of jewelry 114 is held securely to material 116 as a result of the installation of the connector 100. The configuration shown in FIG. 1B is the preferred operational configuration of connector 100. Those skilled in the art, upon reading the teachings of this specification, will appreciate that, under appropriate circumstances, considering such issues as jewelry posts 106 having multiple grooves 103, jewelry posts 106 having irregular or asymmetrical cross-sections, the use of means other than magnets 109 to move the end pieces 108, and ergonomic factors, other designs for engaging member 104, end piece 108, and magnet 109, such as those adapted for particular posts or combinations of posts, those adapted to be actuated for removal by inserted prongs, etc., may be used with connector 100.

FIG. 2 is a sectional elevation illustrating an exemplary jewelry post connector 100 being acted upon by required complimentary separate actuator 200 (hereinafter “actuator”) to move the engaging members 104 and end pieces 108 to a second position, according to the present invention. Actuator 200 includes a housing 202 for housing batteries 204, electromagnets 208, and wiring 212 for coupling the energy from the batteries 204 to the electromagnets 208 under the control of switch 206 having push-button 210. The electromagnets 208 are oppositely disposed across a cavity 203 that is sized, shaped, and arranged to receive connector 100. Considerable variation in the design of housing 202 is comprehended by this disclosure. The primary constraint for the design of a housing 202 for pierced articles of jewelry 114 being that the cavity 203 must be able to receive connector 100 when connector 100 is in place on a pierced human body part. Actuators 200 designed only for articles of jewelry 114 that are used on articles of apparel may be less constrained. Any type of battery (lithium-ion, nickel-Cadmium, lead-acid, etc) may be used for batteries 204. Batteries 204 with high energy densities are preferred. Rechargeable batteries 204 may be used. In a particular embodiment, an alternate energy storage device, such as a small ultracapacitor, may be used in place of batteries 204. In another particular embodiment, an alternate energy supply, such as the output of an appropriately sized transformer plugged into a wall outlet, may substitute for batteries 204. Those skilled in the art, upon reading the teachings of this specification, will appreciate that, under appropriate circumstances, considering such issues as energy supply, location of the article of jewelry 114, and ergonomic factors, other designs for the actuator 200, such as those adapted for a particular body piercing, those adapted to be supplied with energy from various sources, etc., may be used with connector 100.

Each electromagnet 208 is configured to magnetically attract the respectively proximal magnet 109 and to magnetically repel the respectively distal magnet 109. For this to be possible, the magnetic poles of the magnets 109 must be oriented for mutual magnetic repulsion. Preferably, electromagnets 208 are used for actuation, as shown. In an alternate embodiment, the actuator 200 may comprise one or more permanent magnets instead of electromagnets 208. The spring coefficient of the engaging members 104 and the magnetic field strengths of magnets 109 are preferably selected to prevent the repulsive forces of the magnets 109 alone from causing the end pieces 108 to disengage from the jewelry post 106. Those skilled in the art, upon reading the teachings of this specification, will appreciate that, under appropriate circumstances, considering such issues as jewelry posts 106 having multiple grooves 103, jewelry posts 106 having irregular or asymmetrical cross-sections, the use of means other than magnets 109 to move the end pieces 108, and ergonomic factors, other designs for the actuator 200, such as those adapted for particular posts or combinations of posts, those adapted to be actuated for removal by inserted prongs, etc., may be used with connector 100.

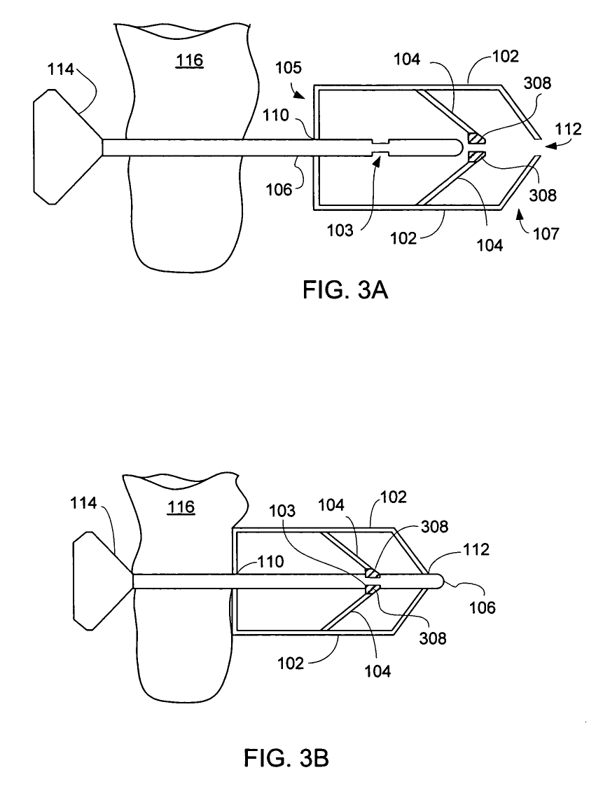

FIG. 3A is a sectional elevation view illustrating an exemplary jewelry post connector 300 in an intermediate position while being installed, according to a second embodiment of the present invention. In the second embodiment, the magnetic end pieces 308 serve both as magnets 109 and as end pieces 108 adapted to fit in groove 103. Opening 110 is preferably sized, shaped, and arranged to slidingly receive jewelry post 106. In a particular embodiment, first end 105 of web 102 may have increased thickness to assist in aligning the jewelry post 106 within the web 102. Those skilled in the art, upon reading the teachings of this specification, will appreciate that, under appropriate circumstances, considering such issues as developments of new jewelry posts 106 or combinations of new jewelry posts 106, such as those adapted for specialized articles of jewelry 114, etc., may be used with jewelry post connector 300.

FIG. 3B is a sectional elevation view illustrating an exemplary jewelry post connector 300 in an installed position, according to a second embodiment of the present invention. Magnetic end pieces 308 are shown engaging groove 103 to prevent manual removal of the jewelry post connector 300 from the jewelry post 106. In some embodiments, web 102 may be decorated. For example and without limitation, the exterior surface of web 102 may be engraved, embossed, anodized, colored, appliquéd, and/or encrusted. Those skilled in the art, upon reading the teachings of this specification, will appreciate that, under appropriate circumstances, considering such issues as developments of new magnetic materials, manufacturing costs, and ergonomic factors, other configurations for magnetic end pieces 308, such as those adapted for particular posts 106 or combinations of posts 106, those adapted to unique jewelry posts 106, etc., may be used with connector 300.

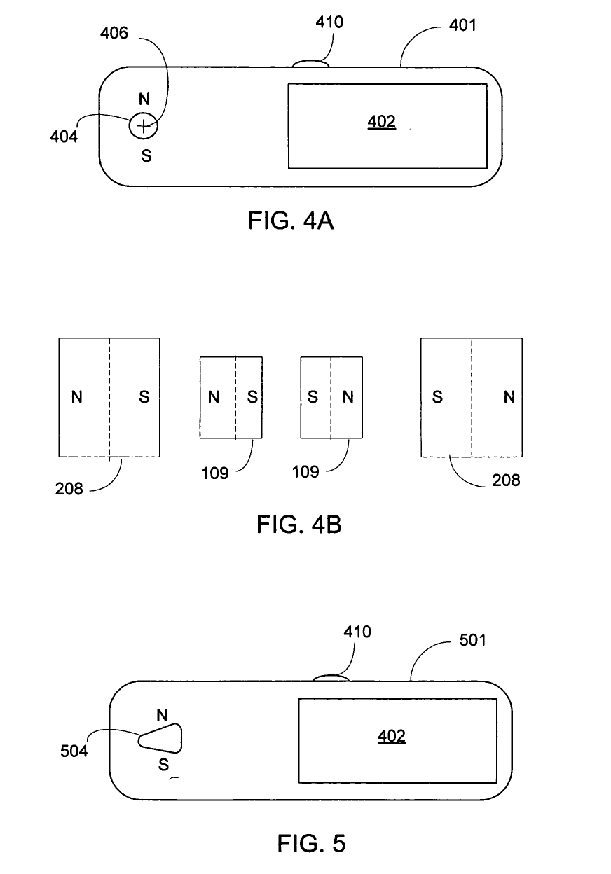

FIG. 4A is a plan view illustrating an exemplary complimentary separate actuator 400 according to an exemplary embodiment of the present invention. Preferably, case 401 supports a battery compartment lid 402 and a push-button switch 410 and further includes a cavity 404, as shown. Cavity 404 preferably has a cross-sectional shape complimentary to the cross-sectional shape of web 102 (FIG. 1) and a depth sufficient to receive the connector 100 to a point aligning the electromagnets 208 of complimentary separate actuator 400 with the magnets 109 (FIG. 2) of the connector 100. For a cavity 404 having a symmetrical cross section, proper function may require rotating the complimentary separate actuator 400 about a longitudinal axis 406 through the center of the cavity 404, in order to orient the electromagnets 208 inside case 401 to the magnets 109 inside the connector 100. Cavity 404 is preferably marked with pole alignments for the electromagnets 208, as shown. Complimentary separate actuator 400 operates on the same principle as actuator 200. In use, the complimentary separate actuator 400 is manipulated to receive connector 100 into cavity 404, the complimentary separate actuator 400 is oriented to align the electromagnets 208, and the push-button switch 410 is pushed to energize electromagnets 208, thereby magnetically urging magnets 109 away from jewelry post 106 and releasing the connector 100 from jewelry post 106. Those skilled in the art, upon reading the teachings of this specification, will appreciate that, under appropriate circumstances, considering such issues as jewelry with multiple jewelry posts 106, desired uniqueness of the combination of complimentary separate actuator 400 and connector 100, and ergonomic factors, other configurations for cavity 404, such as multiple cavities 404, various cavity 404 shapes, the use of alignment keys, etc., may be used with complimentary separate actuator 400.

FIG. 4B is a block diagram showing the electromagnets 208 of the complimentary separate actuator 400 aligned to the magnets 109 of the connector 100 in the operation position for releasing the connector 100. The polarity of each magnet 109 and 208 is indicated on the diagram using “N” for North and “S” for South. Preferably, the polarity of the magnets 208 of the complimentary separate actuator 400 are oriented to attract the proximal magnet 109 of the connector 100 and to simultaneously repel the distal magnet 109 of the connector 100, as shown.

FIG. 5 is a plan view illustrating an exemplary complimentary separate actuator 500 according to an exemplary embodiment of the present invention. Preferably, case 501 supports a battery compartment lid 402, a pushbutton switch 410, and an asymmetrical cavity 504. Asymmetrical cavity 504 preferably has a cross-sectional shape complimentary to the cross-sectional shape of web 102 (FIG. 1) and a depth sufficient to receive the connector 100 to a point aligning the electromagnets 208 with the magnets 109 (FIG. 2). There is only one orientation by which the asymmetrical cavity 504 can receive the connector 100 having a web 102 having a cross-sectional shape complimentary to the asymmetrical cavity 504. Accordingly, the two magnets 109 within connector 100 are configured to be placed in alignment with electromagnets 208 within the complimentary separate actuator 500 by design. In a particular embodiment for a large article of jewelry 114 (such as a large broach) having a plurality of jewelry posts 106, a single complimentary separate actuator 500 may have a complimentary plurality of asymmetrical cavities 504, each shaped uniquely in the cross-sectional shape of each respective connector 100. Those skilled in the art, upon reading the teachings of this specification, will appreciate that, under appropriate circumstances, considering such issues as advances in technology, new post designs, desired uniqueness of the combination of complimentary separate actuator 500 and connector 100, manufacturing costs, improved magnetic materials and ergonomic factors, other configurations for asymmetrical cavity 504, such as multiple asymmetrical cavities 504, various asymmetrical cavity 504 shapes, the use of alignment keys, etc., may be used with complimentary separate complimentary separate actuator 500.

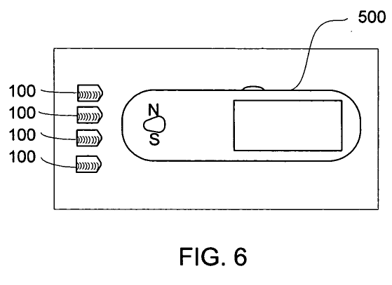

FIG. 6 is a plan view illustrating an exemplary complimentary separate actuator 500 packaged with connectors 100 configured to be used with that complimentary separate actuator 500 according to an exemplary embodiment of the present invention. Preferably, the complimentary separate actuator 500 is sold with one or more connectors 100 and/or 300 in a single package 600. Package 600 is preferably one of various types that allow the consumer to view the product in the package 600. Package 600 may further contain text and images for instructional and advertising purposes. In particular embodiments, the complimentary separate actuator 500 and connectors 100 and/or 300 may be packaged with articles of jewelry 114.

While exemplary embodiments have been presented in the foregoing detailed description of the invention, it should be appreciated that a vast number of variations exist. For example, an actuator 200 that operates by inserting one or more prongs into additional openings in the web 102 in order to mechanically displace engaging members 104 to extract end pieces 108 from groove 103 is within the scope of the invention. Likewise, other approaches to actuating the engaging members 104, including, without limitation, electric, fluidic, and thermal approaches are within the scope of the invention. For example, web 102 may be made of a thermal insulator, while engaging members 104 may be bimetallic strips, which bend when warmed by an electric current. It should also be appreciated that these exemplary embodiments are only examples, and are not intended to limit the scope, applicability, or configuration of the invention in any way. Rather, the foregoing detailed description will provide those skilled in the art with a convenient road map for implementing a preferred embodiment of the invention. It being understood that various changes may be made in the function and arrangement of elements described in an exemplary preferred embodiment without departing from the spirit and scope of the invention as set forth in the appended claims.

What is claimed is:

1. A system for removably securing at least one jewelry post of at least one article of jewelry, the system comprising:
at least one jewelry post connector having at least one engaging member operable in at least one first position to limit motion of such at least one jewelry post of such at least one article of jewelry relative to said jewelry post connector and said at least one engaging member operable in at least one second position to release such at least one jewelry post of such at least one article of jewelry, and
at least one web coupled to said at least one engaging member and configured to prevent direct manipulation of said at least one engaging member by human fingers and further configured to prevent direct manipulation of said at least one engaging member by any means integral to said at least one jewelry post connector.

2. The system of claim 1, further comprising at least one separate actuator operable to move said at least one engaging member from said at least one first position to said at least one second position.

3. The system of claim 2, wherein said at least one separate actuator comprises at least one magnet.

4. The system of claim 2, wherein said at least one separate actuator comprises at least one cavity sized, shaped, and arranged to receive said at least one jewelry post connector.

5. The system of claim 4, wherein said at least one cavity comprises at least one asymmetrical cross section.

6. The system of claim 1, wherein said at least one engaging member is coupled to at least one magnet.

7. The system of claim 1, wherein said at least one engaging member is operable to move to said at least one first position responsive to insertion of such at least one jewelry post into said at least one jewelry post connector.

8. A system for removably securing at least one jewelry post of an article of jewelry, the system comprising:
at least one jewelry post connector, further comprising:
at least one engaging member operable in at least one first position to limit motion of such at least one jewelry post of such at least one article of jewelry and said at least one engaging member operable in at least one second position to release such at least one jewelry post of the at least one article of jewelry; and
at least one web coupled to said at least one engaging member and configured to prevent direct manipulation of said at least one engaging member by human fingers and to prevent direct manipulation of said at least one engaging member by means integral to said at least one jewelry post connector; and
at least one separate actuator operable to move said at least one engaging member from said at least one first position to said at least one second position.

9. The system of claim 8, wherein said at least one separate actuator comprises at least one magnet.

10. The system of claim 8, wherein said at least one separate actuator comprises at least one cavity adapted to receive said at least one jewelry post connector.

11. The system of claim 10, wherein said at least one cavity comprises at least one asymmetrical cross section.

12. The system of claim 8, wherein said at least one engaging member is coupled to at least one magnet.

13. The system of claim 8, wherein said at least one jewelry post connector comprises at least one longitudinal axis and wherein said at least one web comprises at least one asymmetric cylindrical cross-section transverse to said at least one longitudinal axis.

14. A system for removably securing at least one jewelry post of an article of jewelry, the system comprising:
at least one jewelry post connector comprising:
at least one engaging member operable in at least one first position to limit the motion of such at least one jewelry post of such at least one article of jewelry and operable in at least one second position to release such at least one jewelry post of such at least one article of jewelry;
at least one magnet coupled to said at least one engaging member; and
at least one web coupled to said at least one engaging member and configured to prevent direct manipulation of said at least one engaging member by human fingers and to prevent direct manipulation of said at least one engaging member by any means integral to said at least one jewelry post connector; and
at least one separate actuator operable to move said at least one engaging member from said at least one first position to said at least one second position;
wherein said at least one separate actuator comprises at least one magnet operable to influence the motion of said at least one magnet coupled to said at least one engaging member.

15. The system of claim 14, wherein said at least one separate actuator comprises at least one cavity sized, shaped, and arranged to receive said at least one jewelry post connector.

16. The system of claim 15, wherein said at least one cavity comprises at least one asymmetrical cross section.

17. The system of claim 15, wherein said at least one web comprises at least one asymmetrical cross section.

18. The system of claim 14, wherein said at least one web comprises at least one opening for receiving at least one jewelry post.

19. The system of claim 18, wherein said at least one web comprises at least one additional opening.

20. The system of claim 14, wherein said at least one engaging member comprises two engaging members and further wherein each said at least one magnet coupled to each said engaging member of said two engaging members is oriented to magnetically repel the other.

21. The system of claim 20, wherein said at least one magnet of said at least one separate actuator comprises two opposing magnets each oriented to magnetically repel the other.

22. The system of claim 14, further comprising a package containing at least one said at least one separate actuator and at least one said at least one jewelry post connector.
